(19) United States
(12) Patent Application Publication
(10) Pub. No.: US 2009/0127908 A1
(43) Pub. Date: May 21, 2009

(54) Seat Swivel Mechanism

(76) Inventors: John Kucharski, Brown Deer, WI (US); Kevin E. Hill, Mequon, WI (US)

Correspondence Address: BOYLE FREDRICKSON S.C., 840 North Plankinton Avenue, MILWAUKEE, WI, 53203, US

(21) Appl. No.: 12/245,741

(22) Filed: Oct. 4, 2008

Related U.S. Application Data
(60) Provisional application No. 60/997,776, filed on Oct. 4, 2007.

(51) Int. Cl. B60N 2/14

(52) U.S. Cl. 297/344.24

(57) ABSTRACT

A swivel mechanism for a vehicle seat that includes a plurality of pairs of plates that are rotatively coupled providing a first stage of movement where the seat and at least one plate rotates while displacing out of the way of an obstacle and a second stage where the seat and at least one plate rotates without displacing. In an embodiment, a base plate that remains fixed in a home position while a coupling plate and seat-supporting plate rotate about a first pivot offset from the center of the base plate during the first stage and the seat-supporting plate rotates about a second pivot disposed in a center of the coupling plate during the second stage. The coupling plate is slidably coupled to the base plate and to the seat-supporting plate with at least one guide pin and slot arrangement limiting relative movement during the first and second stages.

### CROSS REFERENCE TO RELATED APPLICATION

This application claims priority under 35 U.S.C. § 119(e) to U.S. Provisional Patent Application No. 60/997,776, filed Oct. 4, 2008, the entirety of which is hereby expressly incorporated by reference herein.

### FIELD OF THE INVENTION

The present invention relates to a swivel mechanism for a seat and more particularly to a swivel mechanism for a vehicle seat, such as a marine seat for a boat or another type of watercraft.

### BACKGROUND

Many seats are made to swivel. However, vehicle seats in recreational watercraft equipped with a swivel mechanism have only been able to be rotated a limited amount before hitting the sidewall or hull of the watercraft. In some instances, the seat includes a fore-aft adjustment mechanism or seat slide that can help provide additional clearance to enable the seat to rotate without hitting any part of the watercraft.

Conventional swivel mechanisms typically are mounted to a fixed pedestal that extends upwardly from a floor or deck of the watercraft. Quite often, the swivel mechanism is fixed to the pedestal such that its axis of rotation is fixed relative to the pedestal. In most instances, the swivel mechanism is centered on the pedestal such that the axis of rotation substantially coincides with the longitudinal axis of the pedestal.

A common type of swivel mechanism has a bearing sleeve that fits on the free end of the tubular pedestal and has a collar that is freely rotatable about the bearing sleeve. The swivel mechanism typically also includes a locking mechanism that enables the collar to be fixed in a manner that prevents it from freely rotating. As previously mentioned, a fore-aft adjustment mechanism or seat slide can be included to enable fore-aft adjustment of a vehicle seat mounted thereto.

U.S. Pat. No. 5,882,076 discloses an example of a lockable swivel mechanism that is of such a pedestal/post and collar design. Before rotating the seat, the seat occupant is typically required to move the seat slide to a more forward fore-aft position in order to avoid interference between the seat and an interior wall of the vehicle. Seat rotation typically is also further limited by other obstacles, such as the steering wheel or other controls of the vehicle, which also require sufficient fore-aft seat positioning to enable the seat to freely rotate.

Where not equipped with a fore-aft adjustment mechanism or seat slide, the seat must be positioned far enough away from any such obstacle to permit uninterrupted rotation. This usually results in the seat being located in a less than optimal position, such as where it takes up valuable interior space that could be better utilized in another manner. This is particularly undesirable where the vehicle is a watercraft because they have such limited space.

Vehicle seats in construction equipment, such as loader backhoes and the like, can also utilize a swivel mechanism of pedestal/post and collar design like that disclosed in U.S. Pat. No. 5,127,621. Another type of swivel mechanism is a pancake swivel mechanism formed of an upper and lower plate with a single centrally located pivot that provides a seat axis of rotation is also used on construction equipment. In any event, such swivel mechanisms are of relatively compact construction given the typically tight packaging requirements found in construction equipment and often face similar obstacles that prevent unobstructed seat rotation.

What is needed is a seat swivel mechanism that is better suited for watercraft vehicle seating applications. What is also needed is a swivel mechanism that is versatile enough to be adaptable for use in construction equipment.

### SUMMARY

The present invention is directed to a swivel mechanism for a seat that preferably is a vehicle seat, such as a marine seat for a boat or a seat for another type of water craft. The swivel mechanism is formed of a plurality of slidably and rotatively coupled plates that are configured so the seat displaces away from an object as it rotates during a first stage of swivel mechanism movement and so it only rotates during a second stage of swivel mechanism movement. In a preferred embodiment, there is a plurality of pairs of, i.e., at least three, rotatively and slidably coupled plates where a plurality of plates rotate relative to another plate during the first stage of swivel mechanism movement and one of the plurality of plates rotates relative to another one of the plurality of plates during the second stage of swivel mechanism movement. A latch arrangement can be employed to releasably retain the seat swivel in a home position where no rotation or displacement has yet taken place and can be configured to releasably latch the swivel mechanism in any number of positions from the home position.

In a preferred embodiment, the swivel mechanism is formed of three plates that are rotatively and slidably coupled. One of the plates is a seat-supporting plate to which a seat, a seat pan, or seat frame can be mounted. Another one of the plates is a base plate that is fixed, such as to a mount of a pedestal, a fore-aft motion mechanism such as a seat slide or a chassis or frame of the vehicle. A further one of the plates is an intermediate plate that rotatively and slidably couples with the seat-supporting plate and the base plate.

The base plate is pivotally connected to the coupling plate by a first pivot that is offset relative to a center of the base plate such that rotation of the coupling plate also simultaneously displaces the coupling plate relative to the base plate. The offset pivot is located to one side of the center such that displacement is away from the other side of the base plate, such as the side located adjacent an obstacle like a boat sidewall or the like. The seat-supporting plate is connected to the coupling plate such that rotation and displacement of the coupling plate relative to base plate during the first stage of swivel mechanism movement also results in like movement of the seat-supporting plate.

The seat-supporting plate is connected to the coupling plate by a second pivot that is located such that the rotational axis of the seat-supporting plate and seat are substantially coincident. In a preferred embodiment, the second pivot is centrally located relative to both the seat-supporting plate and coupling plate. A pair of opposed clamp assemblies can be used to slidably couple the seat-supporting plate to the coupling plate while permitting relative rotation therebetween. Where clamp assemblies are used and the second pivot connects the centers of the seat-supporting plate and the coupling plate, the coupling plate is circular with the clamping assemblies slidably engaging the coupling at or adjacent its outer periphery.

There is at least one guide pin fixed that slidably cooperates with the coupling plate and/or seat-supporting plate in at least partly defining when the first stage of swivel mechanism movement ends and when the second stage of swivel mechanism movement begins. There can be a guide pin fixed to the base plate that rides in a guide slot formed in the coupling plate that is configured to limit the extent of rotation and displacement during the first stage of swivel mechanism movement. There can also be a guide pin fixed to the base plate that rides in a guide slot formed in the seat-supporting plate that is configured to limit at least one of the extent of rotation and displacement of the seat-supporting plate during first stage and the extent of rotation of the seat-supporting plate during the second stage. In a preferred embodiment, there is a first guide pin fixed to the base plate that is received in a first curved slot formed in the coupling plate and also in a curved first leg of a curved slot formed in the seat-supporting plate that limit the extent of seat-supporting and coupling plate motion in the first stage. After the first pin has reached the end of the first slot in the coupling plate and the first leg of the curved slot in the seat-supporting plate, application of additional rotational force by a seat occupant causes the first pin to travel along a second leg of the slot in the seat-supporting plate causing the seat-supporting plate to rotate relative to the coupling plate during the second stage of swivel mechanism motion. The end of the second leg of the slot in the seat-supporting plate can and preferably does define the end of motion of the second stage by defining the end of rotation of the seat-supporting plate relative to the coupling plate.

In a preferred embodiment, movement of the coupling plate and seat-supporting plate relative to the base plate is from a forward facing home position to a position opposed from the home position that can be opposite the home position. In a preferred embodiment, the seat rotates an acute angle during the first stage and rotates an obtuse angle during the second stage.

In a preferred embodiment, there can be a second guide fixed to either the coupling plate or the base plate that rides in another curved slot formed in either the base plate or the coupling slot that also helps slidably couple the plates together while also being able to limit the extent of rotation and/or displacement of the first stage of swivel mechanism motion. In a preferred embodiment, there is a second guide pin fixed to the base plate that rides in a curved slot that is only disposed in the coupling plate and there is a third guide pin fixed to the coupling plate that rides in a curved slot that is only disposed in the base plate. If desired, there can also be a fourth guide pin fixed to the base plate that is received in a home position docking slot formed in the coupling plate.

Numerous other aspects, features and advantages of the present invention will be made apparent from the following detailed description taken together with the below-described accompanying drawing figures.

### BRIEF DESCRIPTION OF THE DRAWINGS

One or more preferred exemplary embodiments of the invention are illustrated in the accompanying drawings in which like reference numerals represent like parts throughout and in which:

FIG. 1 is a perspective exploded view of a vehicle seat assembly equipped with a swivel mechanism constructed in accordance with the present invention;

FIG. 2 is a perspective exploded view of the vehicle seat assembly of FIG. 1 showing the swivel mechanism and a slide exploded;

FIG. 3 is an enlarged perspective exploded view of the swivel mechanism;

FIG. 4 is a perspective view of the swivel mechanism;

FIG. 5 is a perspective view of the swivel mechanism with a top, seat supporting plate removed for clarity;

FIG. 6 is a perspective view of the swivel mechanism with the seat supporting plate and an intermediate coupling plate removed for clarity;

FIG. 7 is a bottom perspective view of the vehicle seat assembly with its latch arrangement disposed in a latch position and the plates of the swivel mechanism located in a forwardly facing home position;

FIG. 8 is a bottom perspective view of the vehicle seat assembly with the latch arrangement released showing relative plate movement of the swivel mechanism and corresponding seat rotation and displacement at an intermediate position of a first stage of swivel mechanism motion;

FIG. 9 is a bottom perspective view of the vehicle seat assembly showing relative plate movement of the swivel mechanism and corresponding seat rotation and displacement at an end of the first stage of swivel mechanism motion before entering a second stage of swivel mechanism motion;

FIG. 10 is a bottom perspective view of the vehicle seat assembly illustrating relative plate movement of the swivel mechanism and corresponding seat rotation at an intermediate location during the second stage of swivel mechanism motion where relative plate movement is rotational without displacement;

FIG. 11 is a bottom perspective view of the vehicle seat assembly illustrating relative plate movement of the swivel mechanism and corresponding seat rotation at an end of the second stage of swivel mechanism motion;

FIG. 12 is a top perspective view of the swivel mechanism with the vehicle seat removed for clarity depicting the plates of the swivel mechanism in the forwardly facing home position with the latch arrangement latch;

FIG. 13 is a top perspective view of the swivel mechanism depicting relative plate movement toward an intermediate location during the first stage of swivel mechanism motion where plate rotation occurs simultaneously with displacement away from one side of the bottom base plate of the swivel mechanism;

FIG. 14 is a top perspective view of the swivel mechanism depicting relative plate movement toward an end of the first stage of swivel mechanism motion and the beginning of the second stage of swivel mechanism motion;

FIG. 15 is a top perspective view of the swivel mechanism depicting relative plate movement toward an intermediate position of the second stage of swivel mechanism motion where rotation occurs without displacement;

FIG. 16 is a top perspective view of the swivel mechanism depicting relative plate movement toward the end position of the second stage of swivel mechanism motion;

FIG. 17 is a top perspective view of the swivel mechanism with a seat-supporting top plate removed for clarity illustrating a plurality of clamp assemblies and an intermediate circular coupling plate located in the forwardly facing home position with the latch arrangement and a latched position;

FIG. 18 is a top perspective view of the swivel mechanism with the seat-supporting top plate removed for clarity illustrating movement of the coupling plate relative to the base plate during the first stage of swivel mechanism rotation where the coupling plate has rotated and displaced relative to the base plate toward an intermediate position;

FIG. 19 is a top perspective view of the swivel mechanism with the seat-supporting top plate removed for clarity depicting movement of the coupling plate relative to the base plate where the coupling plate has rotated and displaced relative to the base plate at an end position of the first stage of swivel mechanism motion where it is disposed at a beginning position of the second stage of swivel mechanism motion;

FIG. 20 is a top perspective view of the swivel mechanism with the seat-supporting top plate removed for clarity depicting rotational movement of the clamp assemblies and the latch arrangement relative to the coupling plate toward an intermediate position of the second stage of swivel mechanism motion; and

FIG. 21 is a top perspective view of the swivel mechanism with the seat-supporting top plate removed for clarity depicting rotational movement of the clamp assemblies and the latch arrangement relative to the coupling plate in reaching the end of the second stage of swivel mechanism motion.

Before explaining one or more embodiments of the invention in detail, it is to be understood that the invention is not limited in its application to the details of construction and the arrangement of the components set forth in the following description or illustrated in the drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

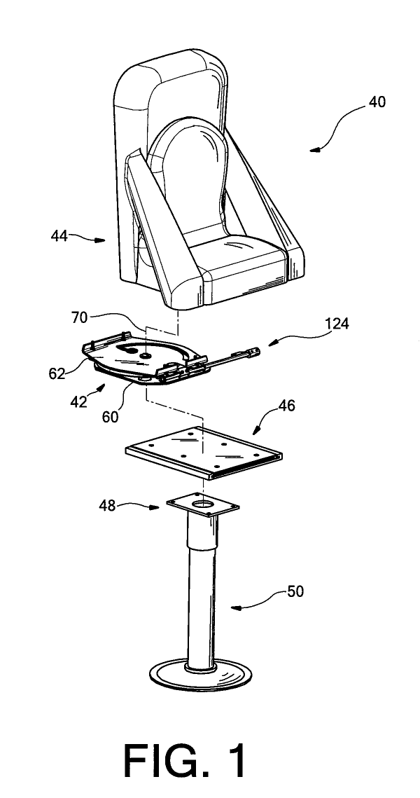

FIG. 1 illustrates a preferred embodiment of a vehicle seat assembly 40 equipped with a swivel mechanism 42 constructed in accordance with the present invention. The vehicle seat assembly 40 includes a seat 44, such as a marine or watercraft seat, that is attached to the swivel mechanism 42. The swivel mechanism 42 can be attached to a fore-aft adjustment mechanism 46, such as a seat slide, that is attached to a mount 48 of a pedestal 50. The pedestal 50 is fixed to a floor of a vehicle (not shown) that can be a watercraft. As is discussed in more detail below, the swivel mechanism 42 is configured to enable a first stage of motion where the seat swivels while simultaneously displacing away from one side and a second stage of motion where the seat swivels without displacement. The first stage where there is rotation with displacement enables the seat to be moved out of the way to clear any obstacles, such as the interior side wall of a boat or other watercraft, steering wheel or the like, before allowing the seat to thereafter purely rotate during the second stage.

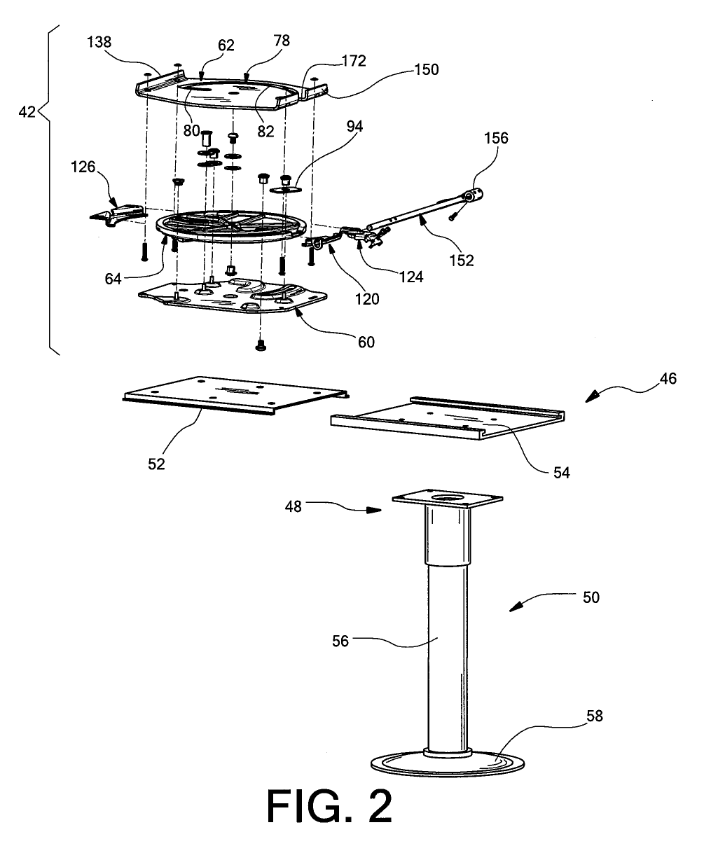

With additional reference to FIG. 2, the seat slide 46 is formed of upper and lower slide plates 52, 54 that slidably engage one another in a manner that permits relative fore-aft motion therebetween to enable fore-aft seat adjustment. The pedestal 50 includes a tubular post 56 received in an annular collar 58 that is fixed to the floor of the watercraft in a conventional manner. Although not shown, the pedestal 50 can be of height adjustable construction.

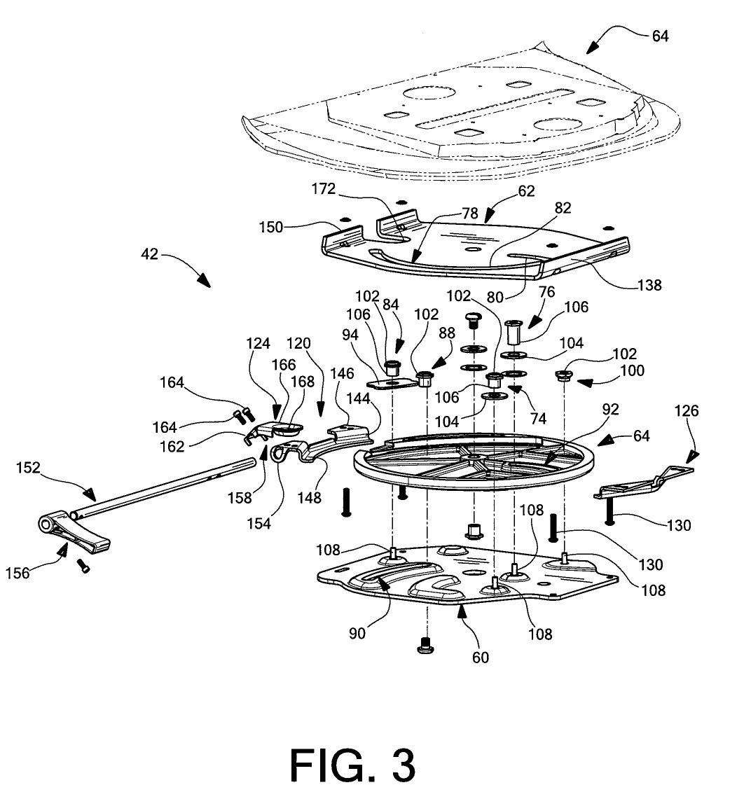

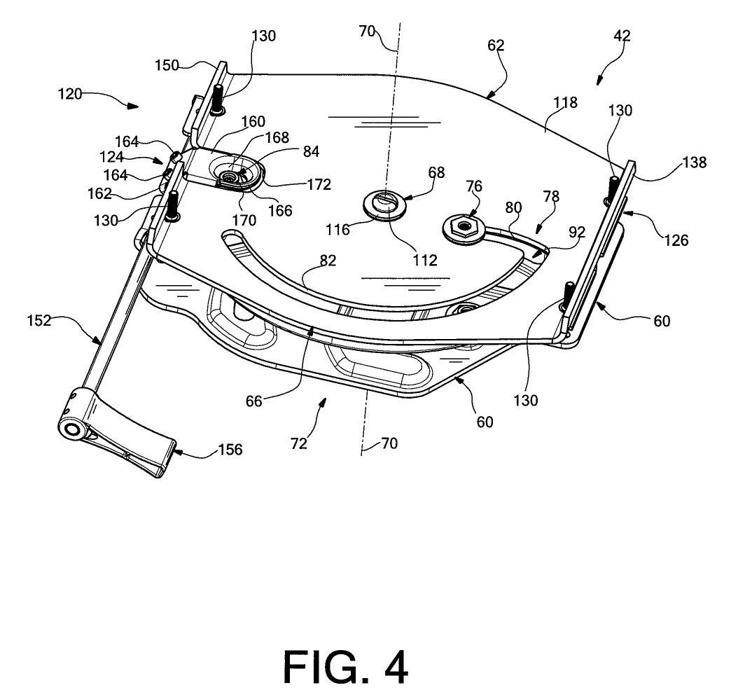

Referring additionally to FIGS. 3-6, the swivel mechanism 42 includes a base plate 60 that is fixed to the upper slide plate 52, a top seat-supporting plate 62 to which a seat pan 64 (shown in phantom in FIG. 3) or the like of the seat 44 is attached, and an intermediate coupling plate 66 disposed between the base plate 60 and seat-supporting plate 62. The seat-supporting plate 62 is pivotally connected to the coupling plate 66 by a centrally located pivot 68 that is generally coaxial with a center line 70 of the swivel mechanism 42 when the plates 62, 66 are disposed in a home position 72, such as is shown in FIG. 4, where no rotation or displacement has occurred. The coupling plate 66 is eccentrically pivotally connected to the base plate 60 by an offset pivot 74 that is offset from the center line 70 such that rotation of the coupling plate 66 relative to the base plate 60 also causes substantially simultaneous displacement of the coupling plate 66 relative to the base plate 60.

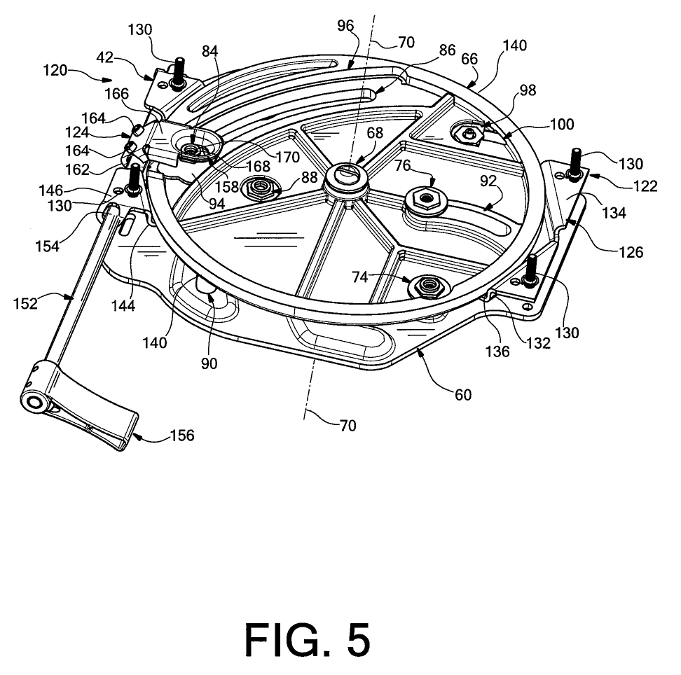

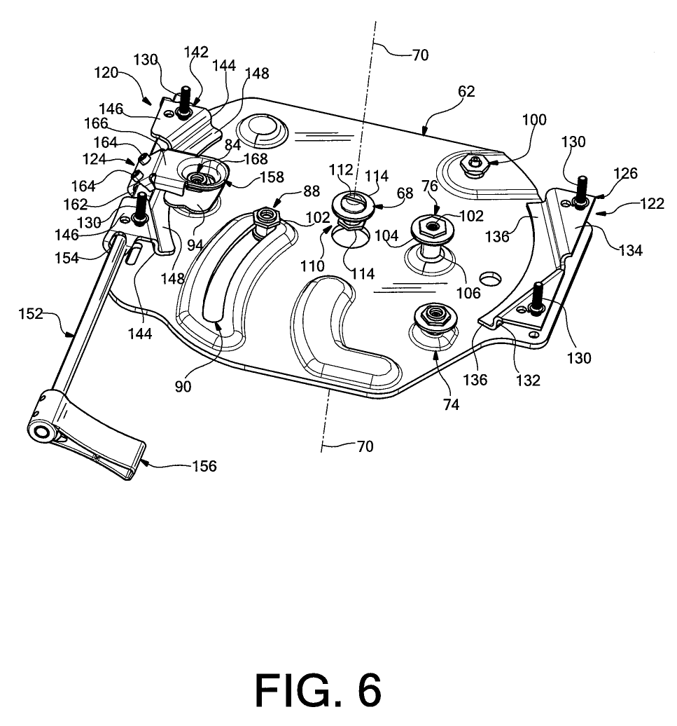

With specific reference to FIG. 4, the seat-supporting plate 62 is slidably coupled to the base plate 60 by a first guide pin 76 that is received in a first guide slot 78 formed in the seat-supporting plate 62 with the slot 78 having a plurality of curved legs 80, 82 with one of the legs 82 being elongate and defining a range of rotational or rotational limit for the second stage of swivel mechanism movement. With specific reference to FIGS. 5 and 6, the coupling plate 66 is also slidably coupled to the base plate 60 by a second guide pin 84 that is received in a second curved guide slot 86 formed in the coupling plate 66, by a third guide pin 88 received in a third curved guide slot 90 formed in the base plate 60, and by the first guide pin 76 being received in a fourth curved guide slot 92 formed in the coupling plate 66 with at least one of the guide slots defining a displacement and rotational limit for the first stage of swivel mechanism movement. Guide pin 84 is attached to an oblong slide plate 94 that is slidably received in a channel 96 formed in the coupling plate 66 that borders and tracks slot 86. There is another guide pin 98 fixed to the base plate 60 that is received in a home position docking slot 100 formed in the coupling plate 66 that is open at one end that is located at or adjacent the outer periphery of the coupling plate 66.

The first leg 80 of guide slot 78 in seat-supporting plate 62 overlaps the guide slot 92 in coupling plate 66 and cooperates with the guide pin 76 at the same time during a first stage of swivel mechanism motion such that seat-supporting plate 62 and coupling plate 66 rotate in unison relative to the base plate 60. Because both plates 62 and 66 are pivotally connected to the base plate 60 by offset pivot 74, which is spaced from centerline 70 of the base plate 60, which remains fixed in home position 72 during first and second stage swivel mechanism movement, rotation of plates 62 and 66 in unison relative to base plate 60 also results in displacement relative to base plate 60 occurring during relative rotation. When guide pin 76 reaches the end of first leg 80 of slot 78 and the end of slot 92, the guide pin 76 is then directed into the second leg 82 of slot 78 in seat-carrying plate 62 thereby causing the seat-carrying plate 62 to rotate relative to the coupling plate 66 about pivot pin 68 that interconnects the two plates 62, 66 during the second stage of swivel mechanism motion.

The first and second guide pins 76, 84 are fixed to the base plate 60 and the third guide pin 88 is fixed to the coupling plate 66. Each pin, such as is exemplified by pin 76, has an outwardly extending flange or the like 102 at its free end and can have a washer 104 disposed between its outer flange 102 and a portion of the plate bordering the guide slot(s) in which the pin 76 rides. In a preferred embodiment, each guide pin 76 is an assembly that includes a tubular spool nut body 106 that is telescopically received over a stud 108 that is fixed to a corresponding one of the plates 60, 62, 66 of the swivel mechanism 42.

While the offset pivot 74 can be of a similar or same construction as the aforementioned guide pin assembly, the central pivot 68 that connects the seat-supporting plate 62 to the coupling plate 66 is a fastener 110 having a head 112 at one end and a nut 114 threaded onto its other end as is best shown in FIG. 6. There also is a washer 116 that is disposed between the fastener head 112 and an outer surface 118 of the seat-supporting plate 62.

There is a pair of clamp bracket assemblies 120, 122 attached to opposite sides of the seat-supporting plate 62 with one of the bracket assemblies 120 carrying a latch arrangement 124 that releasably latches the seat-supporting plate 62 and the coupling plate 66 in the home position 72. Clamp bracket assemblies 120, 122 slidably couple the seat-carrying plate 62 and coupling plate 66 permitting relative rotation therebetween while helping to keep them together in overlapping relationship.

In the preferred swivel mechanism embodiment shown in FIGS. 1-6, the latch arrangement 124 and one of the clamp bracket assemblies 120 are disposed along a front or fore end of the swivel mechanism 42 and the other one of the clamp bracket assemblies 122 is disposed along a rear or aft end of the swivel mechanism 42 when the plates 60, 62 and 66 are disposed in the home position 72.

With reference once again to FIG. 2, the rear or aft clamp bracket assembly 122 includes a clamp bracket 126 that attaches to the seat-supporting plate 62 using a plurality of fasteners 130. Clamp bracket 126 has an outer wall 132 from which extends an outwardly extending mounting flange 134 and an inwardly extending guide or clamping flange 136. As is best shown in FIG. 5, clamp bracket 126 is fixed to the seat-supporting plate 62 by fasteners 130 at or adjacent a rear edge 138 of the plate 62 with its guide flange 136 disposed underneath a portion of an outer peripheral edge 140 of the circularly-shaped coupling plate 66 thereby helping to rotatively clamp the coupling plate 66 between it and the seat-supporting plate 62 in a manner that still allows relative rotation to occur therebetween.

The front or fore clamp bracket assembly 120 is formed of a single clamp bracket 142 that has a similarly configured outer wall 144 from which a similarly shaped mounting flange 146 and guide flange 148 extends. Clamp bracket 142 is fixed to the seat-supporting plate 62 at or adjacent a front edge 150 (FIG. 4) of the plate 62 using fasteners 130 with its clamp or guide flange 148 underlying a portion of the outer peripheral edge 140 of the coupling plate 66 opposite that of the other bracket assembly 122. With both bracket assemblies 120, 122 attached, their guide flanges 136, 148 clamp the coupling plate 66 between them and the seat-supporting plate 62 with sufficient clearance therebetween enabling the coupling plate 66 to rotate relative to the seat-supporting plate 62 while supporting the plates 62, 66 in a manner that prevents them from separating. Such an arrangement advantageously helps produce a robust, strong and smoothly pivoting swivel mechanism 42 that is constructed in accordance with the present invention.

The latch arrangement 124 includes a latch handle 156 attached to a rotary latch shaft 152 that extends through a pair of journal ears 154 of clamp bracket mounting flange 146 and a rotary latch actuator 158 that releasably engages part of the swivel mechanism 42 to prevent plate movement away from the home position 72 when the plates 60, 62, and 66 are disposed in the home position 72. The manipulable handle 156 can be grasped by a seat occupant while sitting in the seat 44 to actuate the latch actuator 158 by rotating the latch shaft 152 to disengage the actuator 158 to permit rotation of the seat 44.

The latch actuator 158 is an elongate or oblong latch plate 160 having a mounting arm 162 attachable to the latch shaft 152 by fasteners 164 and a latching head 166 that engages one of the guide pins, such as forward-most disposed guide pin 84, with an aperture 168 formed therein accepting a head 170 of the pin 84. When the rotary latch shaft 152 is disposed in the latched position, such as is shown in FIG. 4, the latching head aperture 168 receives the head 170 of guide pin 84 such that the latching head 166 is disposed in positive latching engagement therewith preventing any of the plates 62, 66 from moving away from the home position 72. When the latch handle 156 is rotated in a counterclockwise direction, the latching head 166 is rotated upwardly away from the pin 84 through a clearance notch 172 formed in the seat-supporting plate 62 enabling it to be disengaged from the pin 84 permitting relative plate movement between one or more of plates 60, 62, and/or 66 to occur.

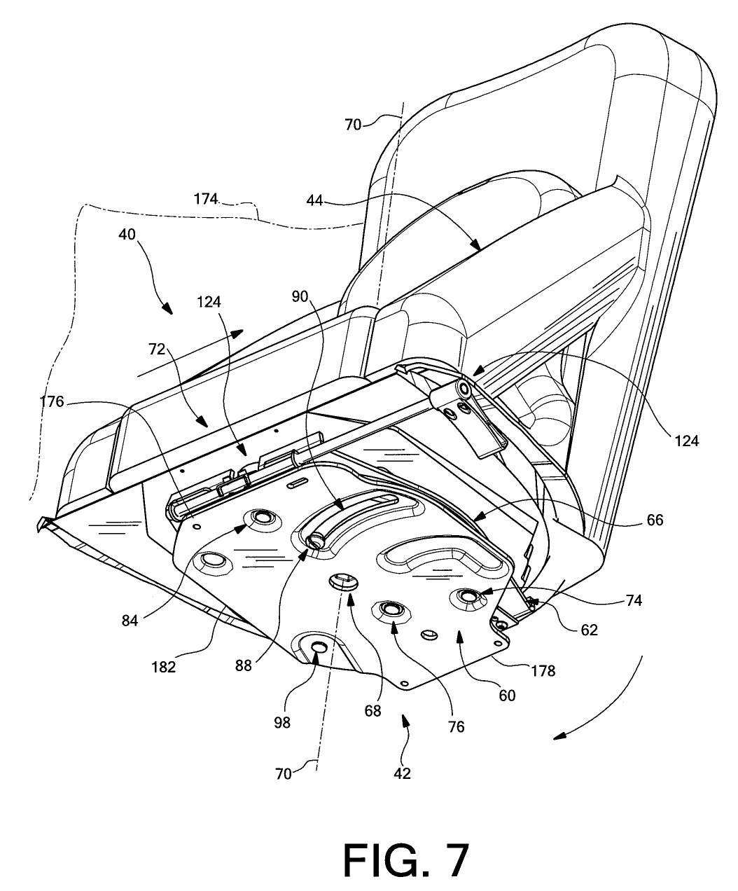

FIGS. 7-11 illustrate use and operation of a vehicle seat assembly equipped with a swivel mechanism constructed in accordance with the present invention. FIG. 7 illustrates the vehicle seat 44, e.g., a marine seat, located in a forwardly facing position with the plates 60, 62 and 66 of the swivel mechanism 42 also disposed in their forwardly facing home position 72 and the latch arrangement 124 disposed in its latched position preventing relative plate movement away from the home position 72. The base plate 60 remains in the home position 72 during swivel mechanism operation with its front edge 176 facing forwardly and its rear edge 178 facing rearwardly as shown in FIG. 7. As is also shown in FIG. 7, the seat 44 is located next to an obstacle 174, such as a sidewall of a watercraft.

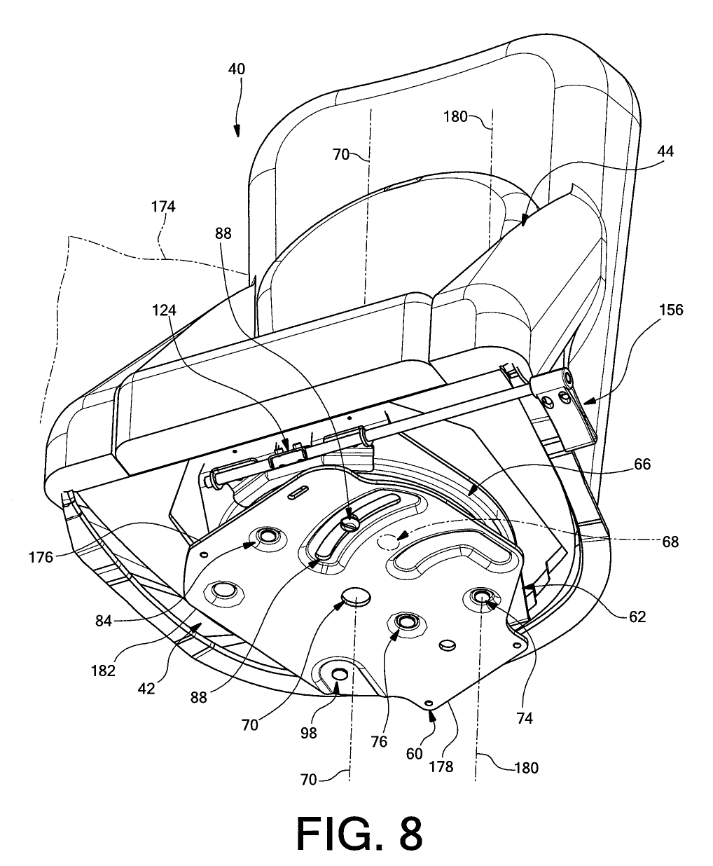

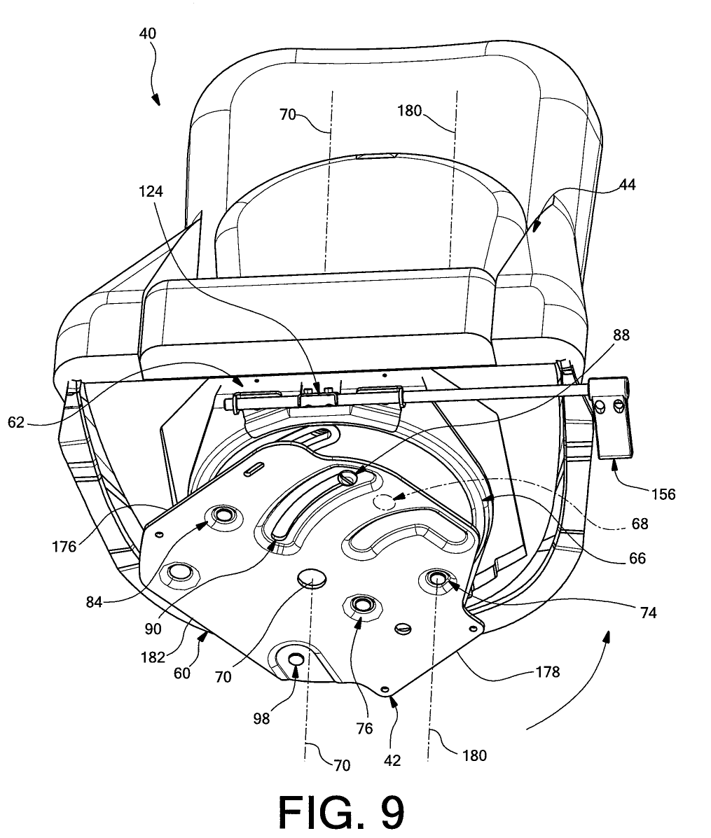

FIG. 8 depicts a first stage of motion of the swivel mechanism 42 where seat-supporting plate 62 and coupling plate 66 rotate in unison about an axis of rotation 180 of the eccentrically located offset pivot 74 such that plates 62, 66 rotate in a clockwise direction while also displacing away from a side edge 182 of the base plate 60 that is located adjacent obstacle 174. Axis of rotation 180 of pivot 74 is spaced from home position centerline 70 such that any rotation about pivot 74 will cause displacement simultaneously with rotation. FIG. 8 shows the seat 44 and plates 62, 66 in an intermediate position of the first stage where guide pin 88 is located in between the ends of guide slot 90. FIG. 9 shows the seat 44 and plates 62, 66 at the end of the first stage where guide pin 88 has reached the end of slot 90. During this first stage of movement, central pivot 68, which is not connected to the base plate 60, moves in unison with plates 62, 66 as depicted in phantom in FIGS. 8 and 9 and is obscured because the base plate 60 remains fixed in the home position at all times. As a result, the seat 44 rotates while simultaneously moving away from the obstacle 174, e.g., watercraft sidewall, enabling the seat 44 to clear the obstacle during the second stage of swivel mechanism motion where only rotation without any displacement occurs.

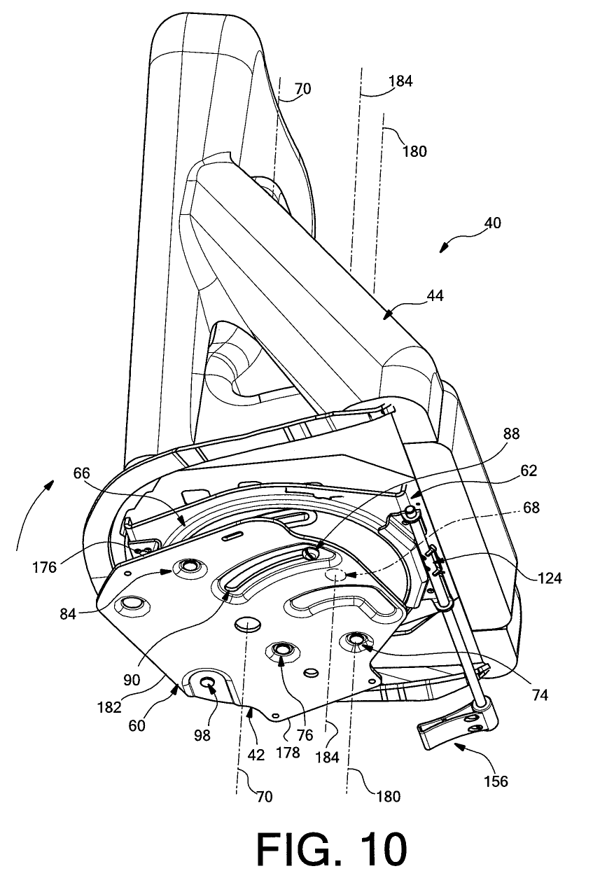

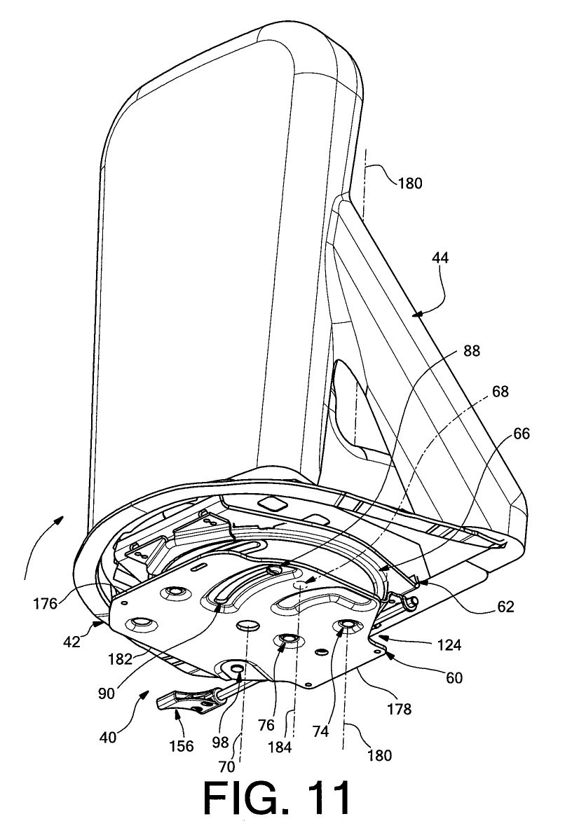

FIG. 10 illustrates operation of the swivel mechanism 42 after it has completed the first stage of motion with it now being in the second stage of motion where rotation takes place without displacement. FIG. 11 depicts completion of the second stage of motion where the seat 44 and hence the seat-supporting plate 62 are located at a point of maximum rotation. When the guide pin 88 reaches the end of travel of slot 90, it serves to limit first stage motion by preventing any further rotation about pivot 74 or axis 180. Thereafter, any additional rotational force applied by a seat occupant to the seat 44 causes the seat 44 and the seat-supporting plate 62 to rotate about an axis of rotation 184 of pivot 68 (shown in phantom in FIG. 10) relative to the coupling plate 66. Since pivot 68 is centrally located relative to the seat-supporting plate 62 and the coupling plate 66, further counterclockwise rotation occurs only about pivot 68. As is also shown in FIGS. 10 and 11, the seat 44 and plates 62, 66 remain at their point of maximum displacement that was reached at the end of the first stage where guide pin 88 reached the end of slot 90.

When the second stage of swivel motion is completed, the seat 44 faces rearwardly opposite where it faced when in the home position. In one preferred embodiment, the seat 44 rotates through an acute angle of about 40° degrees during the first stage of swivel mechanism motion and through an obtuse angle of about 140° such that the seat rotates about 180° from the home position until the point of maximum rotation is reached. The plates, pins and slots of a swivel mechanism 42 constructed in accordance with the present invention can be configured so first stage of rotation rotates through an acute angle of between about 25° and about 85° and the second stage rotates through an obtuse angle of between about 95° and 155°.

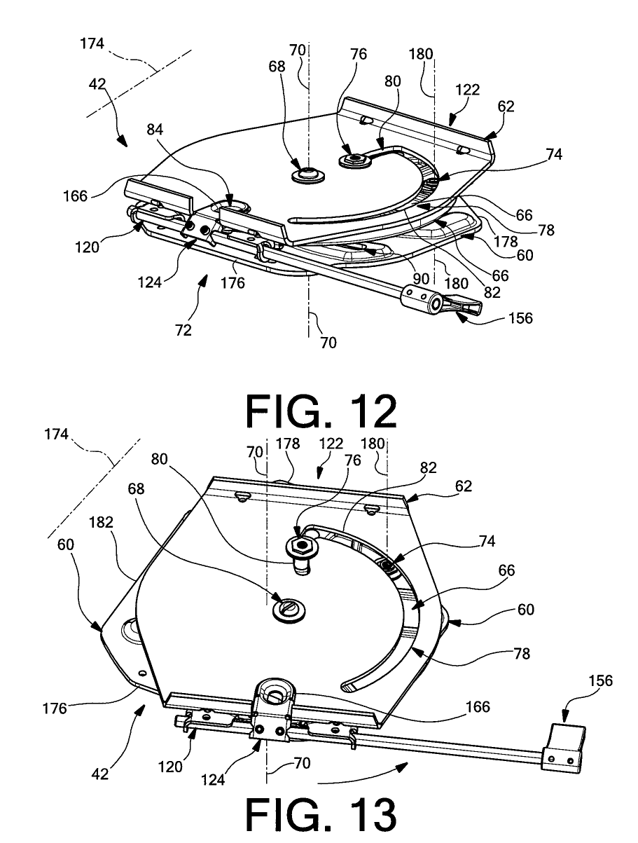

FIGS. 12-16 illustrate the same sequence of staged swivel mechanism operation but with the seat 44 removed for clarity such that the swivel mechanism 42 is shown in a top perspective view looking down on the seat-supporting plate 62. FIG. 12 shows the swivel mechanism 42 with plates 60, 62 and 66 disposed in the home position 72 where a seat occupant sitting in seat 44 faces forwardly in a direction that is generally parallel to sidewall 174 (shown in phantom in FIG. 12). The latch arrangement 124 is shown with its latching head engaged with guide pin 84 that is fixed to base plate 60 thereby preventing movement of seat-supporting plate 62 and coupling plate 66 away from the home position 72 until unlatching occurs. When a seat occupant rotates the latch handle 156 in a direction that causes the latching head 166 to disengage from guide pin 84, it permits the seat occupant to apply a force to the seat 44 to cause the seat to begin to rotate.

FIG. 13 illustrates movement of the seat-supporting plate 62 and the coupling plate 66 as it rotates in unison about eccentrically offset pivot 74 such that the plates 62 and 66 move away from sidewall 174 during rotation about pivot 74. As a result, rotation with displacement of the seat 44 occurs during this first stage of swivel mechanism movement. As plates 62 and 66 rotate about pivot 74, guide pin 76 travels along a first leg 80 of slot 78 formed in the seat-supporting plate 62. As guide pin 76 travels along first leg 80 of slot 78 formed in plate 62, the pin 76 simultaneously travels along slot 92 (FIG. 5) formed in the coupling plate 66. Cooperation between guide pin 76 and leg 80 of slot 78, and guide pin 76 and slot 92, as well as between guide pin 88 and slot 90 formed in base plate 60 (FIG. 7) help guide and limit the range of rotation and displacement that occurs during the first stage of swivel mechanism movement. As is also shown in FIG. 13, base plate 60 remains fixed in the home position 72 during the first stage of swivel mechanism movement.

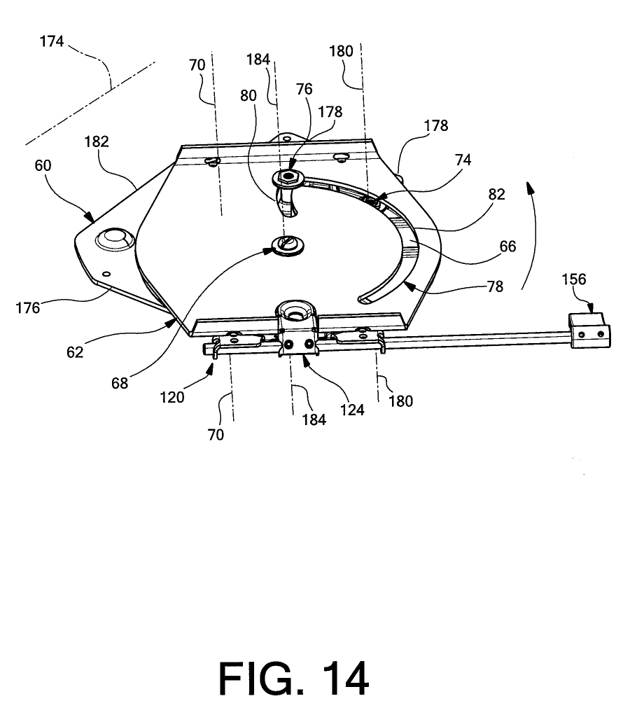

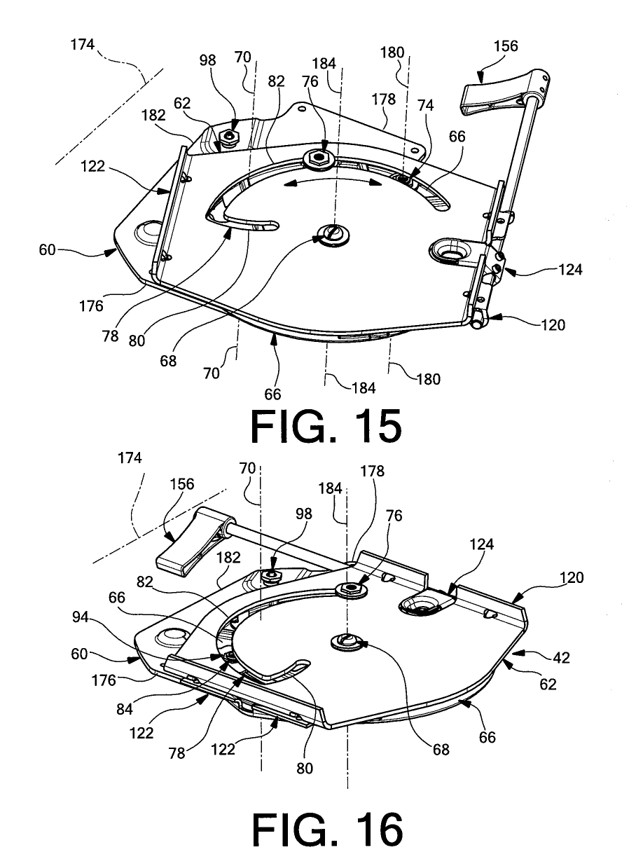

FIG. 14 illustrates rotation of the seat-supporting plate 62 relative to the coupling plate 66 that occurs at the beginning of the second stage of swivel mechanism motion resulting from guide pin 76 reaching the end of slot 92 and/or leg 80 of slot 78 as well as guide pin 88 reaching the end of slot 90. Once these guide pins 76, 88 reach the end of respective slots 92, 90, operation of the swivel mechanism 42 transitions from the first stage to the second stage of swivel mechanism movement such that further force applied by a seat occupant causes seat rotation without any further displacement away from sidewall 174. During the second stage of swivel mechanism motion, seat-supporting plate 62 rotates about pivot 68 relative to the coupling plate 66 without any displacement occurring during rotation. FIG. 15 illustrates that the seat-supporting plate 62 has rotated relative to the coupling plate 66 to an intermediate position during the second stage of swivel mechanism motion such that guide pin 76 is disposed in leg 82 of slot 78 between the beginning of the leg 82 and the end of the leg 82. The arc subscribed by leg 82 along with its radius from pivot 68 defines the range of rotation of the seat-supporting plate 62 relative to the coupling plate 66, e.g., in degrees, during the second stage of swivel mechanism motion. FIG. 16 illustrates the seat swivel 42 at its maximum rotation during the second stage of movement such that the seat-supporting plate 62 has rotated to a position where it faces approximately 180° from the direction it faced when disposed in the home position 72 in FIG. 12. This maximum range of rotation is defined by the end of leg 82 of slot 78 limiting the movement of guide pin 76 in the slot 78.

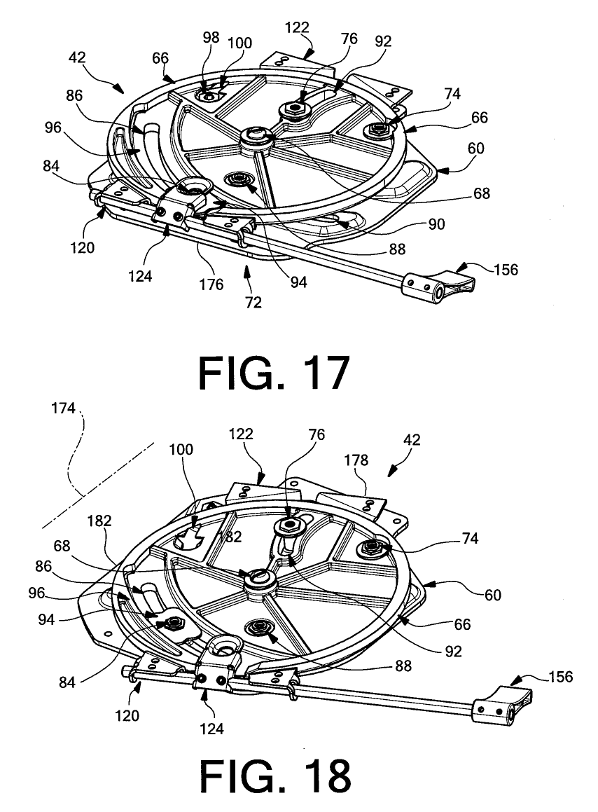

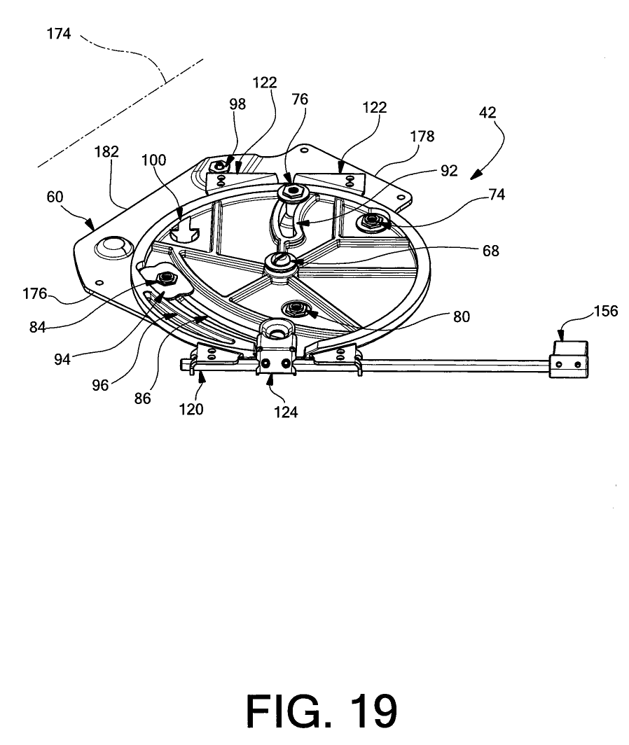

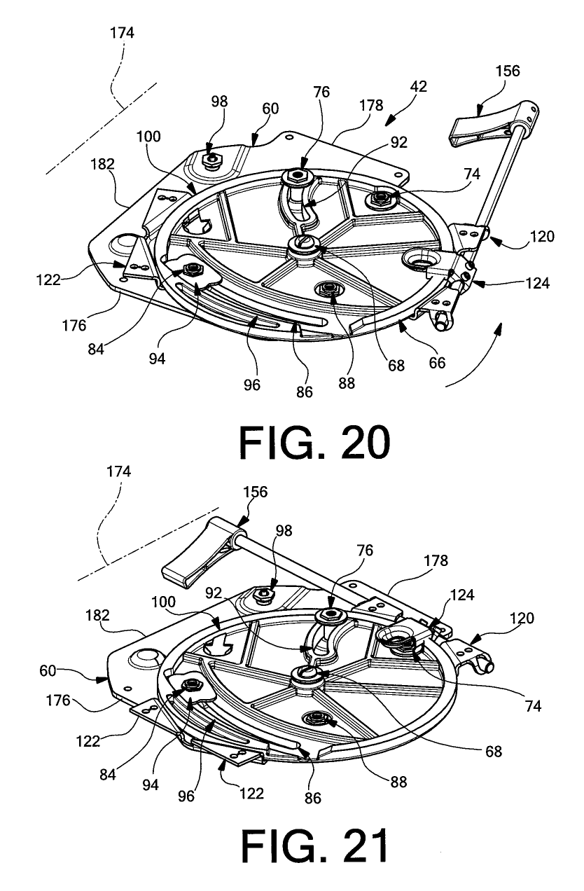

FIGS. 17-21 also illustrate the same sequence of staged swivel mechanism operation but with the seat 44 and seat-supporting plate 62 removed for clarity such that the swivel mechanism 42 is shown in a top perspective view looking down on the coupling plate 66. FIG. 17 shows the relative position of the coupling plate 66 to the base plate 60 when the latch arrangement 124 is latching the plates in the home position 72. FIG. 18 depicts rotation and displacement of the coupling plate 66 relative to the base plate 60 during the first stage of swivel mechanism movement. FIG. 19 illustrates the position of the coupling plate 66 relative to the base plate 60 when the end of the first stage of swivel mechanism movement is reached. FIG. 20 shows the position of the coupling plate clamp assemblies 120, 122 and the latch arrangement 124 during the second stage of swivel mechanism motion with the position of the coupling plate 66 relative to the base plate 60 remaining constant. FIG. 21 shows the position of the coupling plate clamp assemblies 120, 122 and latch arrangement being disposed approximately 180° from the home position shown in FIG. 17 when they have reached the end of the second stage of swivel mechanism movement.

Various alternatives are contemplated as being within the scope of the following claims particularly pointing out and distinctly claiming the subject matter regarded as the invention. It is also to be understood that, although the foregoing description and drawings describe and illustrate in detail one or more preferred embodiments of the present invention, to those skilled in the art to which the present invention relates, the present disclosure will suggest many modifications and constructions, as well as widely differing embodiments and applications without thereby departing from the spirit and scope of the invention.

What is claimed is:

1. A swivel mechanism for a vehicle seat comprising a plurality of pairs of plates that overlie one another when disposed in a home position with a first one of the plates in operable cooperation with a second one of the plates and a second one of the plates in operable cooperation with a third one of the plates wherein a plurality of the first, second and third plates rotates and displaces relative to one of the first, second and third plates during one stage of swivel mechanism movement and wherein one of the plurality of first, second and third plates is rotatable relative to another one of the plurality of first, second and third plates in another stage of swivel mechanism movement.

2. The swivel mechanism of claim 1 wherein the first one of the plates is disposed in operable cooperation with the second one of the plates using a first pivot interconnecting the plates and the second one of the plates is disposed in operable cooperation with the third one of the plates using a second pivot interconnecting the plates.

3. The swivel mechanism of claim 2 wherein one of the plurality of pairs of plates comprises a base plate, a second one of the plurality of pairs of plates comprises a seat-supporting plate that generally overlies the base plate, and a third one of the plurality of pairs of plates comprises a coupling plate disposed between the base plate and the seat-supporting plate with the first pivot pivotally connecting the coupling plate to the base plate permitting relative movement therebetween and the second pivot pivotally connecting the coupling plate to the seat-supporting plate permitting relative movement therebetween.

4. The swivel mechanism of claim 3 wherein the base plate, the coupling plate and the seat-supporting plate each have a center substantially coincident with one another when the base plate, coupling plate and seat-supporting plate are located in the home position, wherein the coupling plate and the seat-supporting plate rotate and displace relative to the base plate during the one stage of swivel mechanism movement such that their centers remain substantially coincident with each other but have their centers spaced from the center of the base plate, and wherein the seat-supporting plate rotates without displacing relative to the coupling plate during the another stage of swivel mechanism movement with their centers remaining substantially coincident.

5. The swivel mechanism of claim 4 wherein the first pivot is spaced from the center of the base plate and the second pivot pivotally connects the coupling plate and the seat-supporting plate along their centers.

6. The swivel mechanism of claim 5 wherein second pivot is aligned with the center of the base plate when the base plate, coupling plate and seat-supporting plate are disposed in the home position and wherein the second position is spaced from the center of the base plate during the one stage and the another stage of swivel mechanism movement.

7. The swivel mechanism of claim 6 wherein the base plate remains in the home position during the one stage and the another stage of swivel mechanism movement.

8. The swivel mechanism of claim 7 wherein the base plate is grounded relative to the vehicle.

9. The swivel mechanism of claim 8 wherein the base plate is fixed to the vehicle.

10. The swivel mechanism of claim 7 wherein the one stage of swivel mechanism movement occurs before the another stage of swivel mechanism movement.

11. The swivel mechanism of claim 1 wherein the first one of the plates is disposed in operable cooperation with the second one of the plates by a first slidable coupling arrangement and wherein the second one of the plates is disposed in operable cooperation with the third one of the plates by a second slidable coupling arrangement.

12. The swivel mechanism of claim 11 wherein the first slidable coupling arrangement comprises at least one first guide projection carried by one of the first and second plates that is received in an elongate first guide formed in the other one of the first and second plates and wherein the second slidable coupling arrangement comprises at least one second guide projection carried by one of the second and third plates that is received in an elongate second guide formed in the other one of the second and third plates.

13. The swivel mechanism of claim 12 wherein the first guide projection comprises a pin extending outwardly from one of the first and second plates and the first guide comprises an arcuate channel formed in the other one of the first and second plates and wherein the second guide projection comprises a pin extending outwardly from one of the second and third plates and the second guide comprises an arcuate channel formed in the other one of the second and third plates.

14. The swivel mechanism of claim 12 wherein first slidable coupling arrangement comprises a first swivel mechanism motion limiter that defines the extent of motion of the one stage of swivel mechanism motion and the second slidable coupling arrangement comprises a second swivel mechanism motion limiter that defines the extent of motion of the another stage of swivel mechanism motion.

15. The swivel mechanism of claim 1 wherein (a) the first one of the plates is disposed in operable cooperation with the second one of the plates via swivel mechanism motion limiting arrangement that slidably couples the first and second plates and limits swivel mechanism movement during the one stage of swivel mechanism motion and (b) the second one of the plates is disposed in operable cooperation with the third one of the plates via second swivel mechanism motion limiting arrangement that slidably couples the second and third plates and limits swivel mechanism movement during the another stage of swivel mechanism motion.

16. The swivel mechanism of claim 1 further comprising a first swivel mechanism motion limiting arrangement that limits swivel mechanism movement during the one stage and a second swivel mechanism motion limiting arrangement that limits swivel mechanism movement during the another stage.

17. The swivel mechanism of claim 16 wherein the first swivel mechanism movement limiting arrangement comprises a first slide arrangement that slidably engages the one of the plates with one of the plurality of plates and the second swivel mechanism movement limiting arrangement comprises a second slide arrangement that slidably engages one of the plurality of plates with another one of the plurality of plates.

18. The swivel mechanism of claim 17 wherein the first slide arrangement comprises a first guide carried by the one of the plates or one of the plurality of plates that is received in a first slot formed in the one of the plurality of plates or the one of the plates that guides the first guide during the one stage of swivel mechanism movement.

19. The swivel mechanism of claim 18 wherein the first slot formed in the one of the plurality of plates or the one plate comprises a curved slot.

20. A swivel mechanism for a vehicle seat comprising:
(a) a base plate;
(b) an intermediate plate that is connected to the base plate by a first pivot;
(c) a seat carrying plate that is connected to the intermediate plate by a second pivot.

21. The swivel mechanism of claim 20 wherein the base plate is grounded to the vehicle, the seat carrying plate has an outer surface upon which the vehicle seat is supported, and the intermediate plate is disposed between the base plate and the seat carrying plate.

22. The swivel mechanism of claim 21 wherein the intermediate plate and seat carrying plate are coupled together for movement in unison therewith relative to the base plate about the first pivot in a first stage of swivel mechanism movement and wherein the seat carrying plate moves relative to the intermediate plate about the second pivot in a second stage of swivel mechanism movement.

23. The swivel mechanism of claim 22 wherein the first pivot defines a first axis of rotation, the second pivot defines a second axis of rotation, and the first and second axes of rotation are generally parallel but not coincident or coaxial.

24. The swivel mechanism of claim 21 wherein the intermediate plate and seat carrying plate are coupled together for movement in unison therewith relative to the base plate about the first pivot in a first stage of swivel mechanism movement where rotation occurs simultaneous with displacement and wherein the seat carrying plate moves relative to the intermediate plate about the second pivot in a second stage of swivel mechanism movement where rotation occurs without simultaneous displacement.

25. The swivel mechanism of claim 20 wherein the base plate and intermediate plate are slidably and rotatively coupled in a manner that permits displacement of the intermediate plate relative to the base plate simultaneously with rotation of the intermediate plate relative to the base plate.

26. The swivel mechanism of claim 25 wherein the intermediate plate and seat carrying plate are slidably and rotatively coupled in a manner that permits relative rotation therebetween without permitting relative displacement therebetween.

27. The swivel mechanism of claim 26 wherein the base plate is grounded to the vehicle and has a first center and the first pivot is offset from the center.

28. A method of operation of a swivel mechanism of a vehicle seat comprising:
(a) providing a plurality of pairs of plates rotatively and slidably coupled to one another;
(b) rotating a plurality of plates to one of the plates while displacing the plurality of plates relative to the one of the plates; and
(c) rotating one of the plurality of plates relative to another one of the plurality of plates.

29. The method of claim 28 wherein a first one of the plurality of pairs of plates comprises a base plate, a second one of the plurality of pairs of plates comprises a seat-supporting plate which carries a seat, and a third one of the plurality of pairs of plates comprises an intermediate coupling plate with the base plate pivotally and slidably coupled to the intermediate coupling plate for rotation and displacement of the intermediate coupling plate relative to the base plate during step (b) and the intermediate coupling plate pivotally and slidably coupled to the seat-supporting plate for rotation of the seat-supporting plate relative to the intermediate coupling plate with displacement during step (c).

30. The method of claim 29 wherein the seat-supporting plate and seat rotate while displacing relative to an obstacle in step (b) until the seat clears the obstacle and thereafter the seat-supporting plate and seat rotate without displacement in step (c)
